(19) United States
(12) Patent Application Publication
(10) Pub. No.: US 2007/0193324 A1
(43) Pub. Date: Aug. 23, 2007

(54) Roll forming apparatus and method of roll forming

(75) Inventors: Kazuhiro Mitsukawa, Inchinomiya-city (JP); Kunihiko Nakashima, Nagoya-city (JP); Naohisa Miyashita, Okazaki-city (JP); Kuniharu Teshima, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/494,000

(22) Filed: Jul. 27, 2006

(30) Foreign Application Priority Data
Jul. 27, 2005 (JP) 2005-217903

(51) Int. Cl. B44B 5/00

(52) U.S. Cl. 72/197

(57) ABSTRACT

A roll forming apparatus for forming projections on a band plate at predetermined internals with respect to a longitudinal direction of the band plate has a carrying roll between an upstream forming roll unit and a downstream forming roll unit. Projections having a first shape are formed on the band plate by an upstream projection forming roll and an upstream recession forming roll of the upstream forming roll unit. The projections having the first shape are formed into projections having a second shape that is steeper than the first shape by a downstream projection forming roll and a downstream recession forming roll of the downstream forming roll unit. Also, the band plate is carried in a sprocket manner that the projections formed in the upstream forming roll unit sequentially engage with projections of the upstream projection forming roll, recessions of the carrying roll, and projections of the downstream projection forming roll.

### CROSS REFERENCE TO RELATED APPLICATION

This application is based on Japanese Patent Application No. 2005-217903 filed on Jul. 27, 2005, the disclosure of which is incorporated herein by reference.

### FIELD OF THE INVENTION

The present invention relates to a roll forming apparatus for continuously forming projections on a band plate at predetermined intervals in a longitudinal direction of the band plate and a method of the same.

### BACKGROUND OF THE INVENTION

In general, a heat exchanger has plural tubes. Therefore, it is desired to manufacture the tubes by roll forming, which has high productivity. For example, a tube having a simple and constant cross-sectional shape throughout its longitudinal direction is formed by a roll forming in which a coil of a metallic band plate is continuously processed, as described in Japanese Patent Publication No. 2004-9087. FIG. 9 shows a main part of a conventional roll forming apparatus 100 that is used to form a flat tube and the like.

Further, a high-performance tube shown in Japanese Patent Publication No. 2004-3787 is also known as a tube for a heat exchanger. The high-performance tube has projections on its outer wall to improve efficiency of heat transfer to an outer fluid (e.g., air). Outer fluid passages through which the outer fluid flows are formed by hollowed portions defined between the adjacent projections in the form of grooves.

The above high-performance tube is for example formed by using a formed plate on which the projections are continuously formed at predetermined intervals in its longitudinal direction. Also, the efficiency of heat transfer is increased as steepening, i.e., with an increase in an angle of the projection with respect to a plane surface of the plate.

However, in a case that the above projection is formed by a single roll forming step, a thickness of the plate is likely to be reduced, and the projection is limited to a comparatively large and gentle shape. To form steep projections, the forming having multiple steps with pilot pins such as a pressing is required.

Also, as an apparatus for forming the projections continuously at predetermined intervals in the longitudinal direction of the band plate, a roll forming apparatus 200 shown in FIG. 10 is proposed. The roll forming apparatus 200 has upstream forming rolls 200A that have projections and recessions on their circumferential walls for forming projections 202 and downstream forming rolls 200B arranged downstream of the upstream forming rolls 200A.

However, the roll forming apparatus 200 shown in FIG. 10 is not provided with positioning mechanisms with respect to the longitudinal direction of the band plate. As a result, forming positions are likely to be displaced between an upstream step and a downstream step, causing problems such as cracks and a decrease of thickness.

### SUMMARY OF THE INVENTION

The present invention is made in view of the foregoing matter, and it is an object to provide a roll forming apparatus and a method of roll forming, which are capable of reducing positional displacement with respect to a longitudinal direction of a band plate in forming a plurality of projections continuously at predetermined intervals in the longitudinal direction of the band plate.

According to an aspect of the present invention, a roll forming apparatus for forming projections on a longitudinal band plate continuously at predetermined intervals with respect to a longitudinal direction of the band plate has an upstream forming roll unit, a downstream forming roll unit arranged downstream of the upstream forming roll unit and an intermediate roll arranged between the upstream forming roll unit and the downstream forming unit. The upstream forming roll unit has an upstream projection forming roll that has first projections on its outer peripheral wall and an upstream recession forming roll that has first recessions on its outer peripheral wall for engaging with the first projections. Projections having a first shape are formed on the band plate by inserting the band plate between the first projections and the first recessions. The downstream forming roll unit has a downstream forming roll having second projections on its outer peripheral wall and downstream recession forming roll having second recessions on its outer periphery for engaging with the second projections. By inserting the projections, which have been formed into the first shape by the upstream forming roll unit, between the second projections and the second recessions, the projections having the first shape are formed into projections having a second shape that is steeper than the first shape. Further, the intermediate roll has third recessions on its outer peripheral wall for receiving the projections formed into the first shape by the upstream forming roll unit.

The band plate is fed from the upstream forming roll unit to the downstream forming roll unit while engaging with the third recessions of the intermediate roll. As such, displacement of forming positions of the projections in the longitudinal direction of the band plate is reduced. Accordingly, positional displacement in the longitudinal direction of the band plate can be reduced even in forming the projections, which have the shape that is difficult to be formed in a single forming step, through plural forming steps.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic perspective view of a stacked-type heat exchanger for showing an overall structure thereof, the heat exchanger having tubes that are constructed of formed plates formed by a roll forming apparatus according to a first embodiment of the present invention;

FIG. 2 is a schematic perspective view of a main part of a heat exchanging potion of the stacked-type heat exchanger shown in FIG. 1;

FIG. 3A is a schematic view of a main part of the roll forming apparatus according to the first embodiment of the present invention;

FIGS. 3B to 3D are schematic enlarged views of portions circled by dashed lines IIIB to IIID of FIG. 3A, respectively;

FIG. 3E is a schematic enlarged view for showing a part of a formed plate that is formed by the roll forming apparatus shown in FIG. 3A;

FIG. 4A is a graph showing the amount δ of positional displacement with respect to a forming length L;

FIG. 4B is an explanatory view for showing the amount δ of displacement of a forming position in a longitudinal direction of a band plate caused in a roll forming having plural forming steps;

FIG. 5A is a schematic view for showing structure of a main part of a roll forming apparatus according to a second embodiment of the present invention;

FIGS. 5B and 5C are schematic enlarged views of portions circled by dashed lines VB and VC in FIG. 5A, respectively;

FIG. 6A is a schematic view for showing structure of a main part of a roll forming apparatus according to a third embodiment of the present invention;

FIGS. 6B to 6E are schematic enlarged views of portions circled by dashed lines VIB to VIE of FIG. 6A, respectively;

FIG. 7 is a schematic view of a part of a band plate for explaining the amount δ of positional displacement in a longitudinal direction of the band plate shown by marks according to the third embodiment of the present invention;

FIG. 8 is a perspective view of an offset fin according to another embodiment of the present invention;

FIG. 9 is a schematic perspective view of a main part of a roll forming apparatus for forming a flat tube as a prior art; and

FIG. 10 is a schematic perspective view of a main part of a roll forming apparatus for continuously forming projections on a metallic band plate as a related art.

### DETAILED DESCRIPTION OF EXAMPLE EMBODIMENTS

Hereafter, example embodiments of the present invention will be described in detail with reference to accompanied drawings.

### First Embodiment

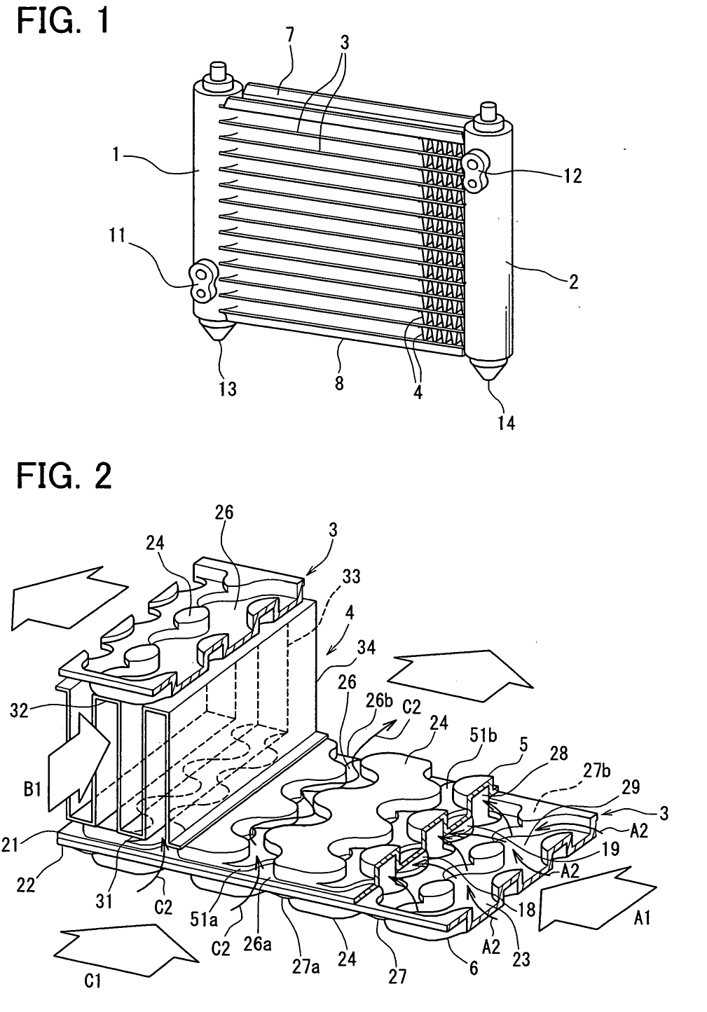

A roll forming apparatus and a method of roll forming according to a first embodiment of the present invention is for example employed to manufacture heat exchanging tubes of a stacked-type heat exchanger shown in FIG. 1. First, a structure of the stacked-type heat exchanger will be described with reference to FIGS. 1 and 2.

The stacked-type heat exchanger (hereafter, heat exchanger) shown in FIG. 1 is for example used as a refrigerant condensing device (condenser) of a refrigerating cycle of a vehicle air conditioning unit mounted to a vehicle such as an automobile. The heat exchanger is for example mounted at a location effectively receiving airflow, which is created while vehicle is traveling, in an engine compartment of the vehicle.

The heat exchanger has a first header tank 1 (left side in FIG. 1), a second header tank 2 (right side in FIG. 1) and plural heat exchanging tubes (hereafter, tubes) 3 and plural corrugated fins (hereafter, fins) 4. The fins 4 are composed of fins that are not formed with louvers, for example. In this heat exchanger, a refrigerant as a first fluid flows in an inside thereof. The heat exchanger performs heat exchange between the refrigerant and air that flows outside of the heat exchanger as a second fluid. The fins 4 are arranged to contact outer walls of the tubes 3 as heat conducting members for improving efficiency of heat exchange between the refrigerant and the air.

The first header tank 1 and the second header tank 2 are provided with a first connecting block 11 and a second connecting block 12, respectively. The tubes 3, the fins 4, the first and second connecting blocks 11, 12 are coated with brazing materials and integrally joined by brazing in a furnace.

The first header tank 1 is for example made of a metal such as an aluminum alloy and is in a form of cylindrical container. The first header tank 1 is formed with plural through holes (not shown). Ends (left ends in FIG. 1) of the tubes 3 are joined with the first header tank 1 by brazing in a condition that the ends of the tubes 3 are inserted in the through holes.

Also, the first connecting block 11 is joined adjacent to an end (lower end in FIG. 1) of the first header tank 1 by brazing. An inlet pipe (not shown) is coupled to the first connecting block 11 for introducing the refrigerant into the first header tank 1.

The second header tank 2 is made of a metal such as an aluminum alloy and is in a form of cylindrical container. The second header tank 2 is formed with plural through holes (not shown). The other ends (right ends in FIG. 1) of the tubes 3 are joined to the second header tank 2 by brazing in a condition that the other ends of the tubes 3 are inserted in the through holes.

Also, the second connecting block 12 is joined adjacent to an end (upper end in FIG. 1) of the second header tank 2 by brazing. An outlet pipe (not shown) is coupled to the second connecting block 12 for discharging the refrigerant from the second header tank 2.

Here, the first header tank 1 and the second header tank 2 are provided with engaging projections 13, 14 at ends (lower ends in FIG. 1) thereof to fix the heat exchanger onto a vehicle body.

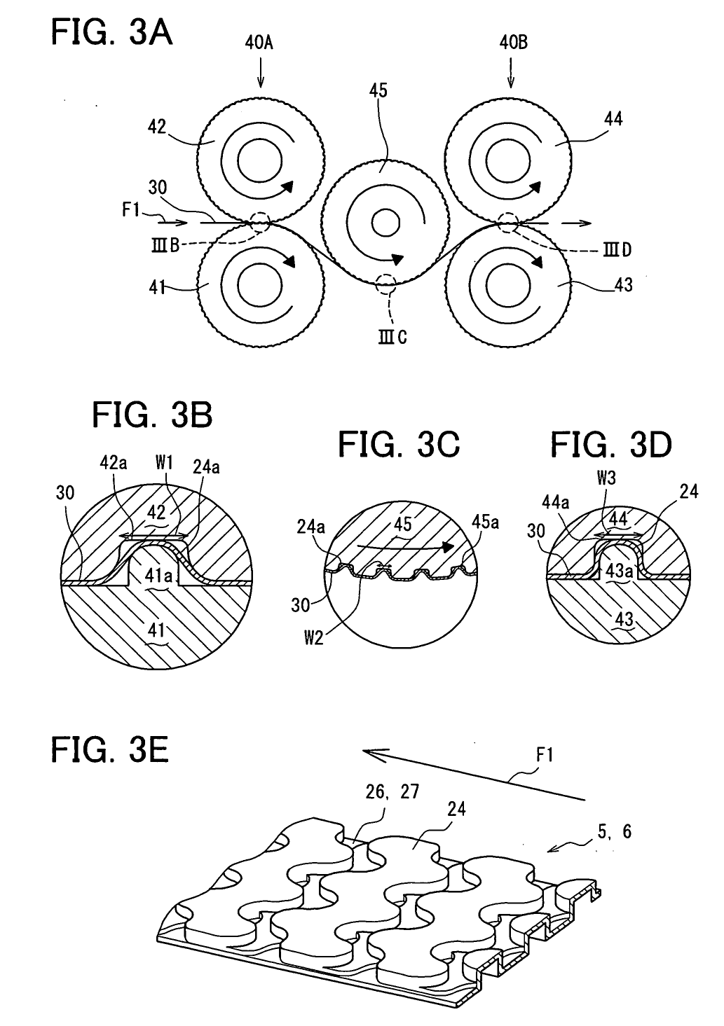

As shown in FIG. 2, each of the tubes 3 forms a refrigerant passage (first fluid passage) 23 therein through which the refrigerant flows. In the heat exchanger, the tubes 3 are stacked at predetermined intervals in a stacking direction (up and down direction in FIG. 1). Each of the tubes 3 is formed by joining a pair of formed plates 5, 6 by brazing. The formed plates 5, 6 are formed by the roll forming apparatus shown in FIG. 3A.

In FIG. 2, arrows A1 denote a general flow direction of the refrigerant flowing in the tubes 3, and arrows C1 denote a general flow direction of the air flowing outside of the tubes 3. Also, an arrow B1 denotes a flow direction of the air flowing through the fins 4.

Each of the formed plates 5, 6 has plural projections 24 projecting from its base wall 21, 22. Plural recessed portions 26, 27 are defined between the adjacent projections 24. The formed plates 5, 6 are paired such that the base walls 21, 22 are opposed to each other, and the refrigerant passage 23 is defined in the paired formed plates 5, 6.

Each of the projections 24 has side walls extending from the base wall 21, 22 and having a wave form and an end wall located at ends of the side walls to close the ends of the side walls. Namely, the projections 24 are formed to rise from the periphery (i.e., the base walls 21, 22 and the recessed portions 26, 27) by a predetermined dimension.

Each of the recessed portions 26, 27 forms a fluid passage (second fluid passage) through which the air flows on the outside of the tube 3. Each recessed portion 26, 27 forms a groove of a wave form corresponding to the shape of the projection 24. Each recessed portion 26, 27 has an inlet side opening 26a, 27a at an upstream end of the tube 3 with respect to the flow direction C1 of the air to introduce the air into the recessed portion 26, 27.

Also, an outlet side opening 26b, 27b is formed at a downstream end of the tube 3 with respect to the flow direction C1 of the air to discharge the air from each recessed portion 26, 27. Here, as shown by arrows C2 in FIG. 2, the air flows through the recessed portions 26, 27 in a wave form and serpentine manner from the inlet side openings 26a, 27a to the outlet side openings 26b, 27b.

Further, step portions 51a, 51b, each having e.g., 0.65 mm in height, are formed at positions adjacent to the inlet side openings 26a, 27a and the outlet side openings 26b, 27b of the recessed portions 26, 27 in the form of grooves. The flow of air is further disturbed by the step portions 51a, 51b. As such, the efficiency of heat transfer to the air can be improved. However, it is not always necessarily to form the step portions 51a, 51b.

Moreover, as shown in FIG. 2, the pair of formed plates 5, 6 is opposed and joined to each other such that the projections 24 and the recessed portions 26 of the formed plate 5 are slightly staggered from the projections 24 and the recessed portions 27 of the formed plate 6 in the longitudinal direction (left and right direction in FIG. 2) and the projections 24 of the respective plates 5, 6 project in opposite directions.

As such, the refrigerant flows, in each tube 3, through a recessed portion 28 formed inside of the projection 24 of the formed plate 5, a recessed portion 29 formed inside of the projection 24 of the formed plate 6, the recessed portion 28 and the recessed portion 29 in this order, as shown by arrows A2 in FIG. 2.

Accordingly, the refrigerant flows in the refrigerant passages 23 in a manner alternately passing through the recessed portions 28 formed inside of the projections 24 of the formed plate 5 and the recessed portions 29 formed inside of the projections 24 of the formed plate 6, i.e., repeating serpentine flows from the first header tank 1 to the second header tank 2.

The above tube 3 is produced by joining the formed plates 5, 6 at the base walls 21, 22, the formed plates 5, 6 being formed by a roll forming apparatus shown in FIG. 3A. Alternatively, the tube 3 can be produced by folding a single formed plate at a center thereof and joining at ends. Here, the formed plates 5, 6, which constructs the tube 3, are made of aluminum alloy, for example.

Each of the fins 4 is formed by pressing a metal band plate that is in a form of a thin plate and made of aluminum alloy, for example. The fin 4 has a predetermined corrugate shape, as shown in FIG. 2. Each fin 4 has flat wall contact portions 31, 32 at positions corresponding to peaks and bottoms of the corrugate shape. The wall contact portions 31, 32 of the fin 4 are defined by flat portions each having a predetermined length, and are joined to the end walls of the projections 24 of the formed plates 5, 6 by brazing.

Also, the fin 4 has connecting portions 33, 34 connecting the wall contact portions 31, 32. Each of the connecting portions 33, 34 has a flat plate shape. In the example shown in FIG. 2, the connecting portions 33, 34 are not formed with louvers. When viewed in the air flow direction C2, the wall contact portions 31, 32 and the connecting portions 33, 34 form substantially rectangular shapes. As shown in FIG. 1, the fins 4 and the tubes 3 are alternately stacked. Further, side plates 7, 8 are joined to outer sides of the fins 4 that are stacked at the outermost sides by brazing. Also, the stack of the fins 4 and the tubes 3 constructs a heat exchanging portion (core portion) of the heat exchanger.

In this heat exchanger, the refrigerant as an inner fluid flows into the first header tank 1 from the first connecting block 11. Then, the refrigerant is distributed into the plural tubes 3 from the first header tank 1.

In each tube 3, heat of the refrigerant is transferred to entire surfaces of the tubes 3 and entire surfaces of the fin 4 through the wall contact portions 31, 32, which contact the end walls of the projections 24 of the tubes 3. Further, the heat is transferred to the air (B1) that flows through the fins 4 outside of the tubes 3 in a direction substantially perpendicular to the longitudinal direction of the tubes 3. As such, the refrigerant as the inner fluid is condensed and liquefied. The refrigerant, heat of which has been exchanged with the air, flows into the second header tank 2 from the tubes 3, and then flows out through the second connecting block 12.

Further, as shown in FIG. 2, since the refrigerant flows in the refrigerant passage 23 formed inside of the tube 3 while separating and merging as shown by arrow A2, the flow of the refrigerant is disturbed. As such, heat can be efficiently transferred in each tube 3. Also, the air flowing outside of the tubes 3 is divided into a flow of arrow B1 passing through the fin 4 that defines an enlarged heat transfer surface and a flow of arrow C2 passing through the recessed portions 26, 27 from the inlet side openings 26a, 27a formed at the upstream ends (upstream end with respect to the air flow) of the tube 3.

Then, the flow of air denoted by the arrow B1 in FIG. 2 absorbs heat from the fin 4 while smoothly flowing along the fin 4, thereby cooling the fin 4. Thereafter, the air flows out from the downstream end of the fin 4. Also, the flow of air denoted by the arrow C2 in FIG. 2 absorbs heat from the walls of the tube 3 (the pair of formed plates 5, 6) while flowing through the recessed portions 26, 27 in the serpentine manner, thereby cooling the tube 3. Thereafter, the air flows out of the outlet side openings 26b, 27b formed at the downstream end (downstream end portion with respect to the air flow).

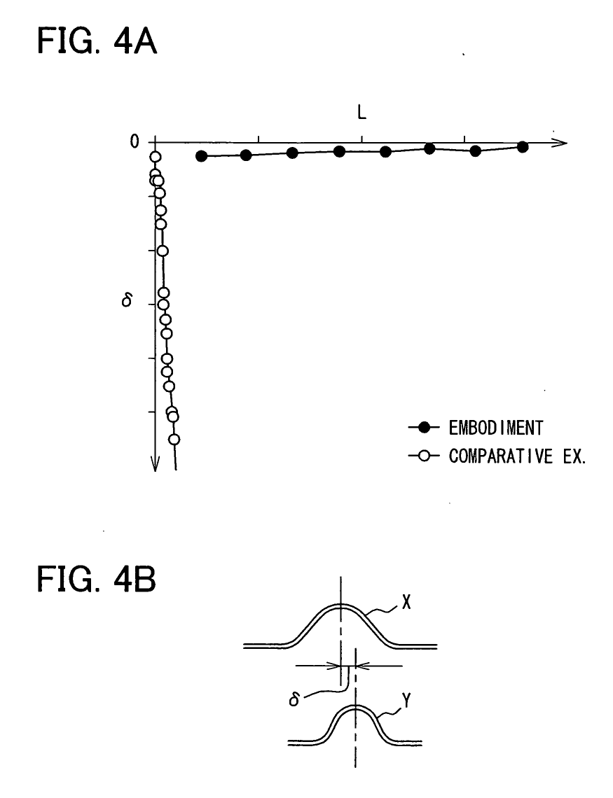

Next, the roll forming apparatus for forming the formed plates 5, 6 having the above projections with complicated shape and the method of forming the formed plates 5, 6 will be described with reference to FIGS. 3A through 4. As shown in FIG. 3A, the roll forming apparatus forms the projections 24 on the longitudinal thin metal ban plate 30 continuously at the predetermined intervals in the longitudinal direction of the band plate 30 through plural forming steps 40A, 40B.

The roll forming apparatus has an upstream roll unit providing an upstream forming step 40A and a downstream roll unit providing a down stream forming step 40B. The downstream roll unit is located downstream of the upstream roll unit. The upstream roll unit has an upstream projection forming roll 41 and an upstream recession forming unit 42.

As shown in FIG. 3B, the upstream projection forming roll 41 has upstream projections (first projections) 41a on its peripheral wall. Also, the upstream recession forming roll 42a has upstream recessions (first recessions) 42a for engaging with the upstream projections 41a on its peripheral wall. In the upstream forming step 40A by the upstream roll unit, large projections 24a are formed on the metal band plate 30.

Also, the downstream roll unit has a downstream projection forming roll 43 and a downstream recession forming roll 44. As shown in FIG. 3D, the downstream projection forming roll 43 has downstream projections (second projections) 43a on its outer peripheral wall. Further, the downstream recession forming roll 44 has downstream recessions (second recessions) 44a for corresponding to the downstream projections 43a of the downstream projection forming roll 43 on its outer peripheral wall.

In the downstream forming step 40B, the projections 24a formed in the upstream forming step 40A is squeezed, so small projections 24 that is smaller than the large projections 24a are formed. Namely, a side wall of the projection 24 formed in the downstream forming step 40B has an angle with respect to a plate surface of the metal band plate 30. The angle is larger than that of the projection 24a, and is closer to 90 degrees than that of the projection 24. In other words, the projection 24a is formed into a first shape in the upstream forming step 40A and then formed into the projection 24 having a second shape that is steeper than the first shape in the downstream forming step 40B.

In addition, the roll forming apparatus has a carrying roll (intermediate roll) 45 between the upstream roll unit and the downstream roll unit for carrying the band plate 30 from the upstream forming step 40A to the downstream forming step 40B. As shown in FIG. 3C, the carrying roll 45 has carrying recessions (third recessions) 45a having the shape capable of receiving the large projections 24a formed in the upstream forming step 40 on its outer peripheral wall.

Further, the metal band plate 30 is carried by the rolls 41 through 45 in the order from a location between the upstream projection forming roll 41 and the upstream recession forming roll 42, a right upper portion (in FIG. 3A) of the outer peripheral wall of the upstream projection forming roll 41, a lower portion (in FIG. 3A) of the carrying roll 45, a left upper portion (in FIG. 3A) of the outer peripheral wall of the downstream projection forming roll 43, to a location between the downstream projection forming roll 43 and the downstream recession forming roll 44. In the drawings, an arrow F1 denotes a feeding direction of the band plate 30.

Also, as shown in FIGS. 3B through 3D, a width W1 of the first recession 42a of the upstream recession forming roll 42 and a width W2 of the carrying recession 45a of the carrying roll 45 are larger than a width W3 of the second recession 44a of the downstream recession forming roll 44 with respect to a circumferential direction of the respective rolls 42, 44, 45.

Next, effects of the embodiment will be described. The roll forming apparatus shown in FIG. 3A has the carrying roll 45, which has the recessions 45a on its outer circumference for receiving the projections 24a formed into the first shape in the upstream forming step on its outer peripheral wall, between the upstream forming step 40A and the downstream forming step 40B. After the upstream forming step 40A, the metal band plate 30 is fed to the downstream forming step 40B sequentially along portions of the outer circumferential walls of the upstream projection forming roll 41, the carrying roll 45, and the downstream projection forming roll 43.

Also, in this roll forming apparatus, all of the rolls 41 through 45 are rotationally driven in a synchronous manner. Further, the rolls 41 through 45 are arranged such that the projections 24a having the first shape sequentially engage with the upstream projections 41a of the upstream projection forming roll 41, the carrying recessions 45a on the peripheral wall of the carrying roll 45, the downstream projections 43a of the downstream projection forming roll 43 in this order in a sprocket manner, in the feeding process from the upstream forming step 40A to the downstream forming step 40B.

As such, in the roll forming having the plural steps 40A, 40B, displacements of forming positions of the projections are reduced in the longitudinal direction of the metal band plate 30. Accordingly, the projections having the shape shown in FIG. 3E, which is generally difficult to be made by a singe forming step, can be formed by this apparatus having the carrying roll 45 in addition to the plural forming steps 40A, 40B.

FIG. 4A shows a graph showing the amount δ of positional displacement with respect to a forming length (distance) L. FIG. 4B is a view for explaining the amount δ of positional displacement of the band plate in the roll forming having the plural steps. In FIG. 4B, numeral X denotes a projection formed in the upstream step and numeral Y denotes a projection shown in the downstream step. According to FIG. 4A, in a roll forming apparatus as a comparative example, which does not have positioning mechanism with respect to the longitudinal direction of the metal band plate 30, the amount δ of positional displacement accumulates and increases with the forming length L.

On the other hand, in the roll forming apparatus of the first embodiment, the projections 24a formed in the upstream forming step 40A are fed to the downstream step 40B while engaging with the carrying recessions 45a of the carrying roll 45 every time the projections 24 are formed. Namely, the carrying recessions 45a serve as pilots. Thus, the band plate 30 are fed such that the position thereof is adjusted by the carrying roll 45. Accordingly, the roll forming apparatus can feed the metal band plate 30 while correcting or absorbing the amount δ of positional displacement. As a result, it is less likely that positional displacement will be largely increased with respect to the longitudinal direction.

Also, the carrying roll 45 has the carrying recessions 45a that can receive the large projections 24a. If the structure of the carrying roll 45 for receiving the large projections 24a is provided by the projection, the large projections 24a are received by the downstream recessions 44a that engages with the small projections 24 in the downstream forming step 40B. In this case, the large projections 24a are likely to be caught by the downstream recessions 44a.

On the other hand, in the roll forming apparatus of the first embodiment, the large projection 24a received in the carrying projection 45a is transferred to the downstream projection 43a having the shape corresponding to the small projection 24. Therefore, it is less likely that the large projection 24a will be bit. Accordingly, the metal band plate 30 can be stably carried.

The carrying roll 45 provides a carrying step for transferring the metal band plate 30 from the upstream projection forming roll 41 to the downstream projection forming roll 43, between the upstream forming step 40A and the downstream forming step 40B.

As such, the projection 24a formed in the upstream forming step 40A is fed to the downstream forming step 40B while sequentially engaging with the upstream projection 41a of the upstream projection forming roll 41, the carrying recession 45a of the carrying roll 45, the downstream projection 43a of the downstream projection forming roll 43. Therefore, the displacement of the forming position of the projections is reduced in the longitudinal direction of the metal band plate 30, and the metal band plate 30 can be formed into the desired shape.

### Second Embodiment

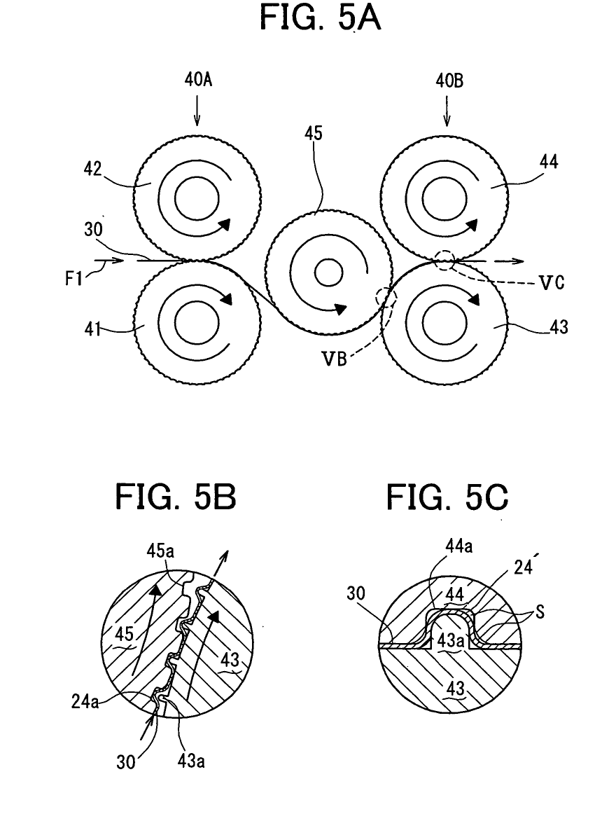

A second embodiment of the roll forming apparatus will be described with reference to FIGS. 5A to 5C. As a feature different from the above-described first embodiment, the carrying roll 45 is arranged such that the carrying projections 45a engage with the downstream projections 43a of the downstream projection forming roll 43 through the large projections 24a of the metal band plate 30 at a part, as shown in FIGS. 5A and 5B.

In this construction, the carrying roll 45 and the downstream projection forming roll 43 engage with each other as gears, and therefore synchronize with each other. Further, since the metal band plate 30 is transferred from the carrying roll 45 to the downstream projection forming roll 43, which partly engage with the carrying roll 45. Therefore, it is less likely that the metal band plate 30 will flap. As such, the positional displacement of the projections in the feeding direction F1 can be further reduced.

Further, as shown in FIG. 5C, the downstream projection 43a and the downstream recession 44a define gaps S that are larger than a thickness of the metal band plate 30 between them. When the large projection 24a is squeezed into the small projection 24, changes of the material caused by roll accuracy, thickness, tensile strength, yield strength, etc. can be absorbed by the gaps S. Namely, while the projection is formed into the second shape from the first shape, portions of the band plate 30 having large forming change can enter the gaps S. For example, between the recession 44a and the projection 43a, the gap S is formed at a position corresponding to the portion 24′ of the band plate 30, the portion 24′ having volume change larger than that of remaining portions during the forming, as shown in FIG. 5C. Accordingly, the positional displacement of the band plate 30 in the longitudinal direction can be further reduced.

### Third Embodiment

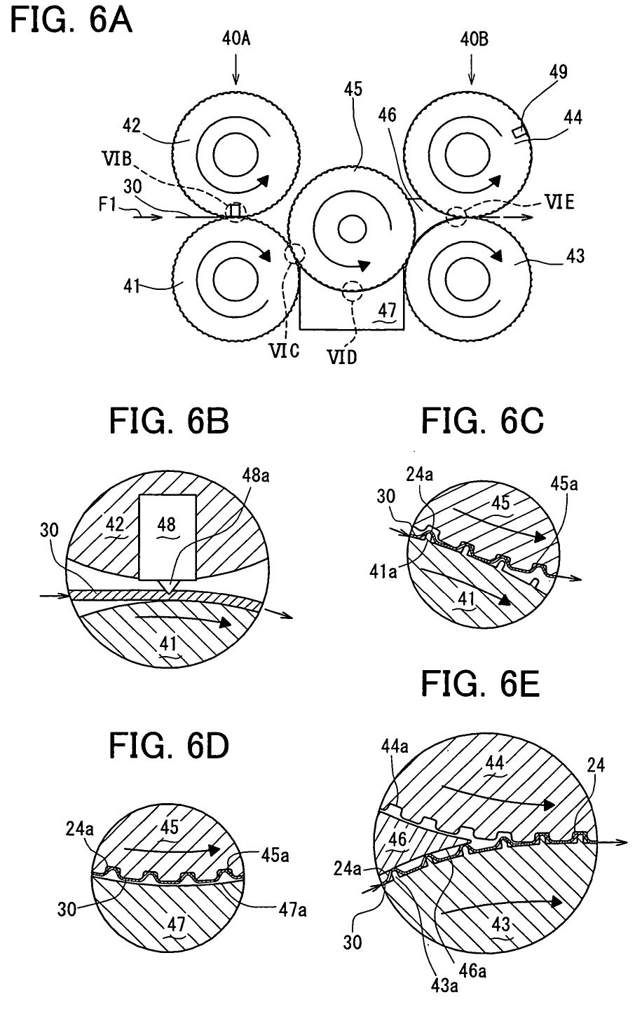

Next, a third embodiment of the roll forming apparatus will be described with reference to FIGS. 6A to 6E. In the roll forming apparatus shown in FIG. 6A, the carrying roll 45 is arranged to engage with the upstream projection forming roll 41 at a part, in addition to the feature of the second embodiment. Namely, as shown in FIG. 6C, the upstream projections 41a of the upstream projection forming roll 41 engage with the carrying recessions 45a of the carrying roll 45 through the large projections 24a of the metal band plate 30.

In this construction, the carrying roll 45 engages and synchronizes with the upstream projection forming roll 41, even if the carrying roll 45 is not operated. Further, since the upstream projection forming roll 41 and the carrying roll 45 engage with each other, it is less likely that the metal band plate 30 will flap while being transferred from the upstream projection forming roll 41 to the carrying roll 45. As such, the metal band plate 30 can be further stably transferred. Thus, the positional displacement in the longitudinal direction can be further reduced.

In addition, the roll forming apparatus shown in FIG. 6A has an inlet guide member (first guide member) 46 between the carrying roll 45 and the downstream forming roll unit 40B, i.e., at the inlet of the downstream forming roll unit 40B. As shown in FIG. 6E, the first guide member 46 forms a guide wall 46a at a position corresponding to the outer periphery of the downstream projection forming roll 43. The guide wall 46a restricts the large projections 24 engaging with the downstream projection 43a from separating from the downstream projection 43a and securely guides the metal band plate 30 to be fed between the downstream projection forming roll 43 and the-downstream recession forming roll 44.

Accordingly, the first guide member 46 restricts the metal band plate 30 from flapping and stably feeds the metal band plate 30 to the downstream forming step 40B. Namely, because the projections 24 can be securely engaged with the projections 43a, positioning accuracy improves. Therefore, the positional displacement in the feeding direction can be further reduced.

In addition to the above, the roll forming apparatus shown in FIG. 6A has a carrying portion guide member (second guide member ) 47. The second guide member 47 forms a guide wall 47a at a position corresponding to the outer peripheral wall of the carrying roll 45. The second guide member 47 restricts the large projections 24a of the metal band plate 30 received in the carrying recessions 45a from separating from the carrying recessions 45a. As such, the flapping of the metal band plate 30 can be restricted also in the carrying step. The metal band plate 30 can be stably transferred to the downstream forming step 40B. Similar to the inlet guide member 46, the positional displacement of the metal bend plate 30 in its longitudinal direction can be further reduced.

Furthermore, the roll forming apparatus shown in FIG. 6A has a first marking member 48 and a second marking member 49 for respectively making marks (impressions) 48′, 49′ on parts of the metal band plate 30. For example, the upstream recession forming roll 42 and the downstream recession forming roll 44 have the first marking member 48 and the second marking member 49, respectively. Alternatively, the upstream projection forming roll 41 and the downstream forming roll 43 can have the first marking member 48 and the second marking member 49, respectively.

As shown in FIG. 6B, the first marking member 48 has a marking block disposed in the upstream recession forming roll 42a and a marking projection 48a that projects from the outer peripheral wall of the upstream recession forming roll 42a. Here, in FIG. 6B, the projections 41a of the roll 41 and the recessions 42a of the roll 42 are not illustrated for convenience of illustration. The second marking member 49 for the downstream recession forming roll 44 have the structure similar to that of the first marking member 48.

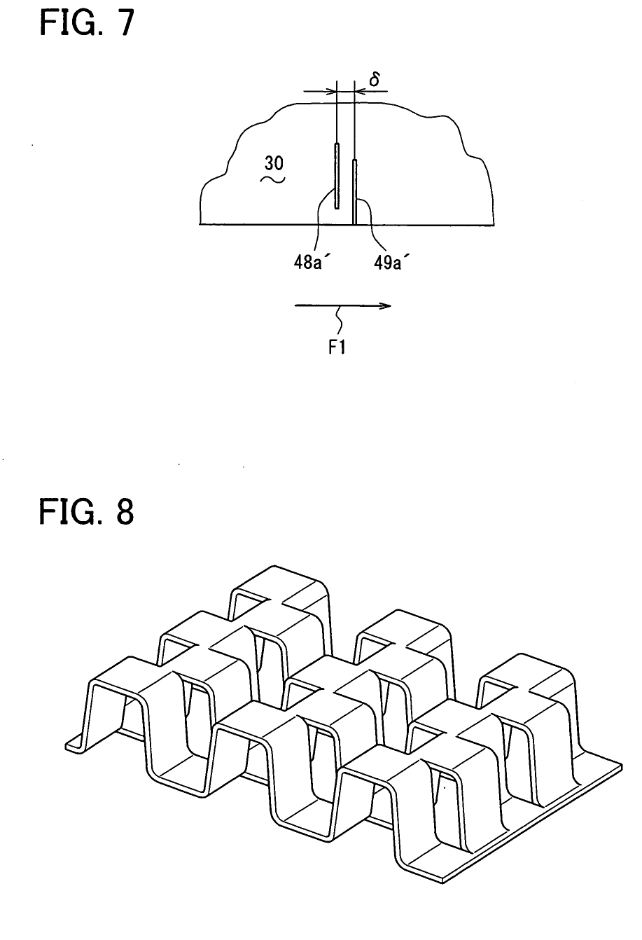

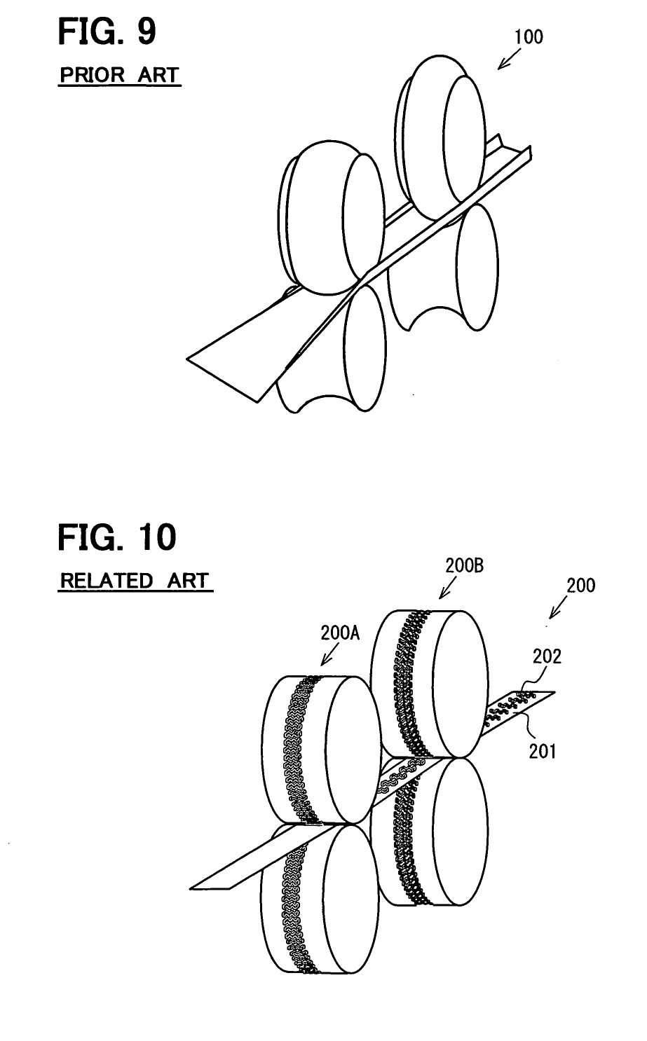

FIG. 7 exemplary shows the marks 48′, 49′ formed on the metal band plate 30. As shown in FIG. 7, the amount δ of the positional displacement caused between the upstream projection 41a and upstream recession 42a of the upstream forming step 40A and the downstream projection 43a and downstream recession 44a of the downstream forming step 40B can be detected according to a distance between the marks 48′ 49′. Namely, the displacement of the metal band plate 30, i.e., the amount of positional displacement in forming the projections can be detected based on the distance between the marks 48′, 49′.

As such, positioning accuracy between the upstream forming step 40A and the downstream forming step 40B can be evaluated by using the marks 48′, 49′. Further, pitches of the axes of the rolls 41 through 45 can be adjusted by using the marks 48′, 49′, thereby easing alignment.

Also, in the embodiment shown in FIG. 6, it is not necessarily that the roll forming apparatus is provided with all of the marking members 48, 49, the inlet guide member 46, and the carrying guide member 47, but one of or some of the preceding members 46 through 49 can be deleted. Further, the preceding members 46 through 49 can be employed to the roll forming apparatus of the first embodiment and the second embodiment, as needed.

### Other Embodiment

In the above first to third embodiments, the roll forming apparatus and the method of roll forming are employed in order to form the formed plates 5, 6 of the tubes 3 of the heat exchanger shown in FIGS. 2 and 3E. However, the use of the above roll forming apparatus and the roll forming method is not limited to the above. The roll forming apparatus and the method of roll forming can be employed to form other members. For example, the above roll forming apparatus and method can be employed to form an offset fin having bending and drawing shapes that need to be processed through plural steps in its longitudinal direction, as shown in FIG. 8.

Further, in the above embodiments, the roll forming apparatus can have another guide member at an outlet of the upstream forming roll unit, i.e., on the outer peripheral portion of the band plate 30 that engages with the upstream projection forming roll 41, to restrict the large projections 24a from separating from the upstream projections 41a. By this construction, the positional displacement in the roll forming having plural steps can be further reduced.

The gaps S of the second embodiment can be also formed in the downstream forming roll unit of the first embodiment and the third embodiment.

The embodiments of the present invention are described above. However, the present invention is not limited to the above embodiments, but may be implemented in other ways without departing from the spirit of the invention.

What is claimed is:

1. A roll forming apparatus for forming a plurality of projections on a band plate at predetermined intervals with respect to a longitudinal direction of the band plate, the apparatus comprising:
an upstream forming roll unit having an upstream projection forming roll and an upstream recession forming roll for forming projections having a first shape on the band plate, the upstream projection forming roll having first projections on its outer peripheral wall, the upstream recession forming roll having first recessions on its outer peripheral wall for engaging with the first projections;
a downstream forming roll unit disposed downstream of the upstream forming roll unit, the downstream forming roll unit having a downstream projection forming roll and a downstream recession forming roll, the downstream projection forming roll has second projections on its outer peripheral wall, the downstream recession forming roll has second recessions on its outer peripheral wall for engaging with the second projections, the downstream forming roll unit disposed for altering the projections having the first shape into projections having a second shape that is steeper than the first shape through engagement of the second projections and the second recessions; and.
an intermediate roll disposed between the upstream forming roll unit and the downstream forming roll unit, the intermediate roll having third recessions on its outer peripheral wall for receiving the projections having the first shape, which are formed in the upstream forming roll unit.

2. The roll forming apparatus according to claim 1, wherein the intermediate roll and the downstream projection forming roll are arranged such that the third recessions engage with the second projections.

3. The roll forming apparatus according to claim 1, wherein each second projection and each second recession define a gap therebetween, the gap being larger than a thickness of the band plate.

4. The roll forming apparatus according to claim 1, wherein the intermediate roll and the upstream projection forming roll are arranged such that the third recessions engage with the first projections.

5. The roll forming apparatus according to claim 1, further comprising:
a first guide member disposed at an inlet portion of the downstream forming roll unit, wherein the first guide member has a guide wall for restricting the projections having the first shape from separating from the second projections.

6. The roll forming apparatus according to claim 1, further comprising:
a second guide member disposed on an outer peripheral side of the band plate received by the intermediate roll, wherein the second guide member has a guide wall for restricting the projections having the first shape from separating from the third recessions.

7. The roll forming apparatus according to claim 1, wherein
one of the upstream recession forming roll and the upstream projection forming roll has a first marking member for marking on a part of the band plate, and
one of the downstream recession forming roll and the downstream projection forming roll has a second marking member for marking on a part of the band plate.

8. The roll forming apparatus according to claim 1, wherein
a width of each first recession of the upstream recession forming roll and a width of each third recession of the intermediate roll with respect to a circumferential direction thereof are greater than a width of the second recession of the downstream recession forming roll with respect to a circumferential direction of the downstream recession forming roll.

9. The roll forming apparatus according to claim 1, wherein the upstream projection forming roll, the intermediate roll, and the downstream projection forming roll are arranged such that the band plate are carried while partly engaging with the upstream projection forming roll, the intermediate roll and the downstream projection forming roll.

10. A method of roll forming for forming a plurality of projections on a band plate at predetermined intervals with respect to a longitudinal direction of the band plate, comprising:
forming projections having a first shape on the band plate by inserting the band plate between first projections formed on an outer peripheral wall of an upstream projection forming roll and first recessions formed on an outer peripheral wall of-a downstream projection forming roll;
carrying the band plate such that the projections having the first shape are received in third recessions formed on an outer peripheral wall of an intermediate roll disposed downstream of the upstream projection forming roll and the upstream recession forming roll; and
forming the projections having the first shape into projections having a second shape that is steeper than the first shape by inserting the band plate, which is carried through the intermediate roll, between second projections formed on an outer peripheral wall of a downstream projection forming roll and second recessions formed on an outer peripheral wall of a downstream recession forming roll.

11. The method of roll forming according to claim 10, wherein
in the carrying, the band plate is carried in a condition that the third recessions are engaged with the second projections.

12. The method of roll forming according to claim 10, wherein
in the carrying, the band plate is carried in a condition that the third recessions are engaged with the first projections.

13. The method of roll forming according to claim 10, further comprising:
making a first mark on the band plate by a first marking member disposed on one of the upstream projection forming roll and the upstream recession forming roll;
making a second mark on the band plate by a second marking member disposed on one of the downstream projection forming roll and the downstream recession forming roll; and
detecting an amount of positional displacement of the projections based on a distance between the first mark and the second mark with respect to a carrying direction of the band plate.

14. The method of roll forming according to claim 10, wherein
in the carrying, the band plate is transferred from the intermediate roll to the downstream projection forming roll.
